(19) United States
(12) Patent Application Publication
(10) Pub. No.: US 2005/0110880 A1
(43) Pub. Date: May 26, 2005

(54) Method for correcting the date/time metadata in digital image files

(75) Inventors: Kenneth A. Parulski, Rochester, NY (US); Michael W. Pryor, Rochester, NY (US); Jay A. Endsley, Fairport, NY (US)

Correspondence Address: Pamela R. Crocker;Eastman Kodak Company, Patent Legal Staff, 343 State Street, Rochester, NY, 14650-2201, US

(73) Assignee: Eastman Kodak Company

(21) Appl. No.: 10/722,880

(22) Filed: Nov. 26, 2003

(51) Int. Cl. H04N 5/76

(52) U.S. Cl. 348/231.5

(57) ABSTRACT

A method for correcting the date/time values associated with digital images captured by a digital camera includes using a digital camera to capture and store a plurality of digital images and to store an associated initial date/time value for each of the plurality of digital images provided by a real-time clock in the digital camera; and establishing communications between the digital camera and a separate device providing a current date/time value. The method further includes determining a current date/time value in the digital camera, and a difference between the current date/time value in the digital camera and the current date/time value in the separate device; and modifying the initial date/time values associated with each of the plurality of digital images to compensate for the difference between the current date/time value in the digital camera and the current date/time value in the separate device in order to correct the date/time values associated with each of the plurality of digital images.

### FIELD OF THE INVENTION

The present invention relates to digital cameras that produce digital image files and, more particularly, to a digital camera that stores the date and time each image was taken within the digital image file.

### BACKGROUND OF THE INVENTION

Digital cameras are used by a growing number of consumer and professional photographers. These cameras use one or more image sensors to capture images, and digitally process the captured images to produce digital image files, which are stored in a digital memory in the camera. The digital image files can then be viewed, stored, retrieved, and printed using a home computer, and can be uploaded to a web site for viewing and printing.

The digital camera typically includes a real-time clock, which provides the current date and time. As each image is captured, the current date/time is determined using the real-time clock, and stored as metadata within the digital image file. When the images are later transferred to a computer for storage, the date/time metadata is very valuable in helping retrieve images of interest (e.g. December 25 for Christmas images).

However, the date/time is only useful if the camera's real-time clock has been properly set. If the camera clock is set to an incorrect time, the date/time data will be in error. In many digital cameras, the real-time clock must be set the first time the camera is used, and then again whenever new batteries are installed in the camera. Unfortunately, users do not want to bother having to set the clock each time they replace the camera batteries, since they may want to immediately capture a picture, or they may not have a watch and calendar handy. If the user does not properly set the clock, a default date and time (such as Jan. 1, 2000 12:00:00 am) is recorded with the captured images. Therefore, the date/time metadata can often provide an incorrect date/time, making it of little use for image retrieval.

Prior art film cameras, such as described in U.S. Pat. No. 5,526,079 to Goto et al. and U.S. Pat. No. 5,579,066 to Miyamoto et al., inhibit recording of the date/time on a picture when battery power is lost or interrupted. This prevents the wrong time from being recorded. But the result is that no date/time is recorded with the images, until the user resets the camera clock. Furthermore, these prior art cameras do not provide assurance that the user has set the proper time when resetting the camera clock.

What is needed is a method for correcting the date/time metadata in image files captured by a digital camera having a real-time clock that was not properly set at the time that the images were captured.

### SUMMARY OF THE INVENTION

It is an object of the present invention to provide a method for correcting the date/time metadata in image files captured by a digital camera using a real-time clock which was not properly set at the time that the images were captured.

This object is achieved by a method for correcting the date/time values associated with digital images captured by a digital camera, comprising:
a) using a digital camera to capture and store a plurality of digital images and to store an associated initial date/time value for each of the plurality of digital images provided by a real-time clock in the digital camera;
b) establishing communications between the digital camera and a separate device providing a current date/time value;
c) determining a current date/time value in the digital camera, and a difference between the current date/time value in the digital camera and the current date/time value in the separate device; and
d) modifying the initial date/time values associated with each of the plurality of digital images to compensate for the difference between the current date/time value in the digital camera and the current date/time value in the separate device in order to correct the date/time values associated with each of the plurality of digital images.

### ADVANTAGES

It is an advantage of the present invention to enable a user to capture images using a digital camera immediately after batteries are inserted into the camera without the user having to set the date/time.

It is another advantage of the present invention to store the correct date/time metadata in an image file when the real-time clock of the digital camera was improperly set when the associated image was captured.

### BRIEF DESCRIPTION OF THE DRAWINGS

FIG. 1 depicts a block diagram of a first digital photography system;

FIG. 2 depicts a block diagram of a digital camera used in the digital photography system of FIG. 1;

FIG. 3 depicts a flow diagram showing a method for correcting the date/time metadata in image files captured by a digital camera in accordance with a first embodiment of the present invention;

FIG. 4 depicts a block diagram of a second digital photography system;

FIG. 5 depicts a block diagram of a digital camera used in the digital photography system of FIG. 4;

FIG. 6 depicts a flow diagram showing a method for correcting the date/time metadata in image files captured by a digital camera in accordance with a second embodiment of the present invention;

FIG. 7 depicts a block diagram of a third digital photography system;

FIG. 8 depicts a block diagram of a digital camera used in the digital photography system of FIG. 7;

FIG. 9 depicts a flow diagram showing a method for correcting the date/time metadata in image files captured by a digital camera in accordance with a third embodiment of the present invention; and

FIG. 10 depicts a flow diagram showing a method for correcting the date/time metadata in image files captured by a digital camera in accordance with a fourth embodiment of the present invention.

### DETAILED DESCRIPTION OF THE INVENTION

The present invention enables a digital camera to take pictures immediately after the batteries are inserted into the camera, without the user needing to set the current date/time. Instead, the camera's real-time clock is initialized to a significantly time-shifted date (e.g., Jan. 1, 1900), and begins counting time from that date/time. As the images are captured and stored by the digital camera, the current date/time is recorded as metadata associated with the stored images. While each image has the wrong absolute date/time, the time difference between when the images were taken is correct. At a later time, which may be hours or many days later, the camera communicates with a separate device, which provides the current date/time. The date/time provided by the separate device is compared with the current date/time of the real-time clock in the digital camera. If there is a significant difference, the time difference between the clocks is determined. This time difference is used to correct the date/time metadata stored in association with the digital images which were captured using the wrong date/time. The real-time clock in the digital camera can also be set to the proper date/time provided by the separate device.

In a first embodiment of the present invention, the separate device is located at a remote Imaging Services Provider, and the digital camera communicates with the imaging services provider over a cellular telephone network. The date/time metadata is corrected as the images are transferred from the digital camera to a remote image storage device controlled by the Imaging Services Provider.

In a second embodiment of the present invention, the separate device is an Internet accessible date/time service, and the digital camera communicates with the date/time service using a wireless local area network.

In a third embodiment of the present invention, the separate device is a personal computer with a real-time clock which can be manually set by a user, and the digital camera communicates with the personal computer using a standard wired interface, such as a USB interface. In this embodiment, the digital camera's real-time clock is compared to the computer's real-time clock when the devices are connected.

In each of these three embodiments, if there is a significant time difference between the digital camera's real-time clock and the clock in the separate device, the camera's real-time clock is set to match the clock in the separate device, and the images having obviously incorrect dates (e.g., dates from the early 1990s, before the camera was even designed) have their date/times shifted by the proper offset. The proper offset is simply the difference between the date/time of the current digital camera's real-time clock and the “proper” time. In the third embodiment, prior to updating the digital camera's real-time clock and shifting the date/time values of the images, the user can be instructed to confirm that the computer's time/date is correct.

In a fourth embodiment of the present invention, the user sets the digital camera's real-time clock after capturing images. The date/time of the images taken before the real-time clock was properly set are corrected by determining the proper offset between the digital camera's real-time clock just before the user set the time, and the time set by the user.

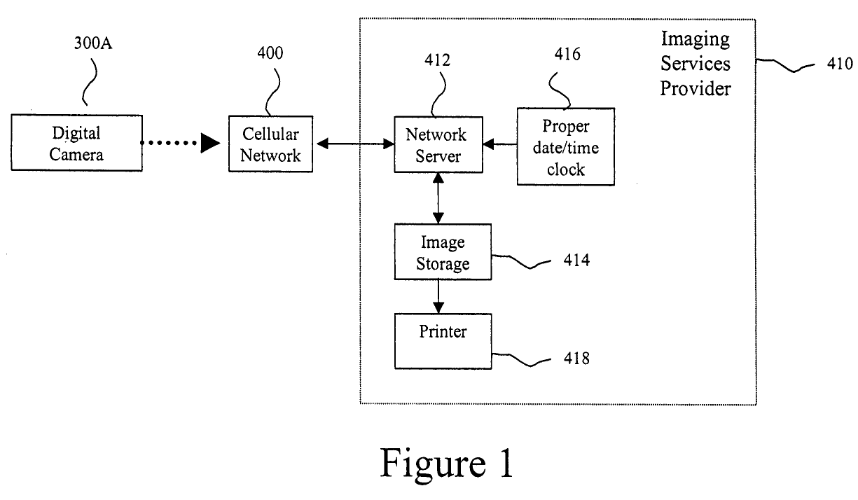

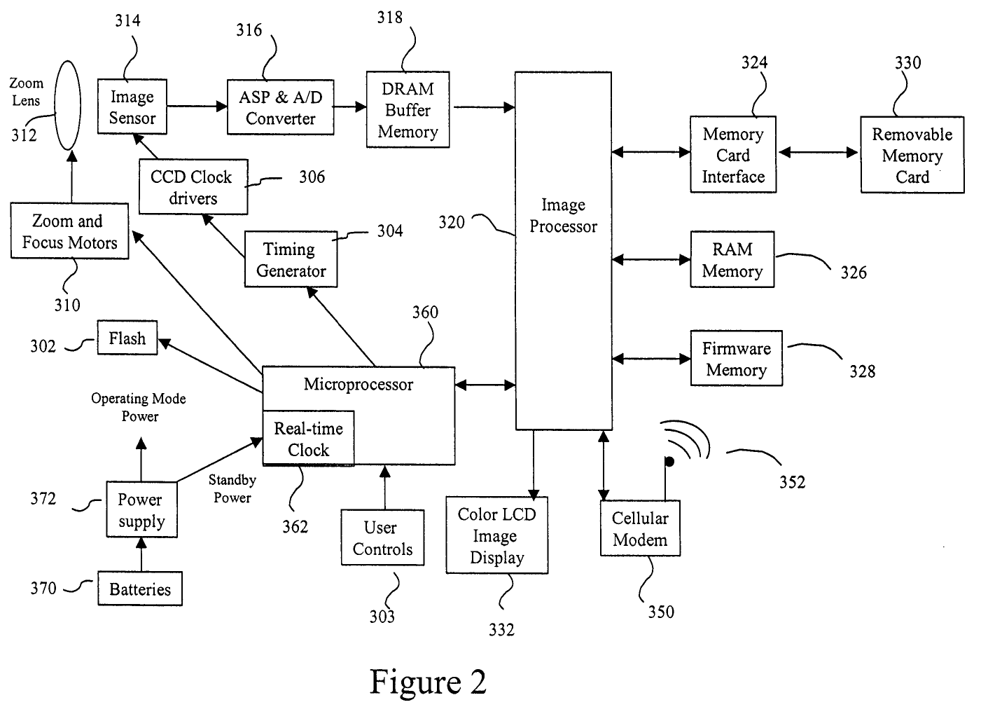

Referring to FIG. 1, there is illustrated a digital photography system in accordance with the present invention. As shown in FIG. 1, the system includes a digital camera 300A that captures still images and motion video images, stores initial date/time metadata associated with the images, and transmits the images using a cellular modem, as will be described later with reference to FIG. 2. The digital camera 300A is one example of an imaging device that can be used in a digital photography system made in accordance with the present invention. Other examples of imaging devices include still-only or motion video-only digital cameras, and combination cell phone/digital cameras that can capture and transmit digital still and video images.

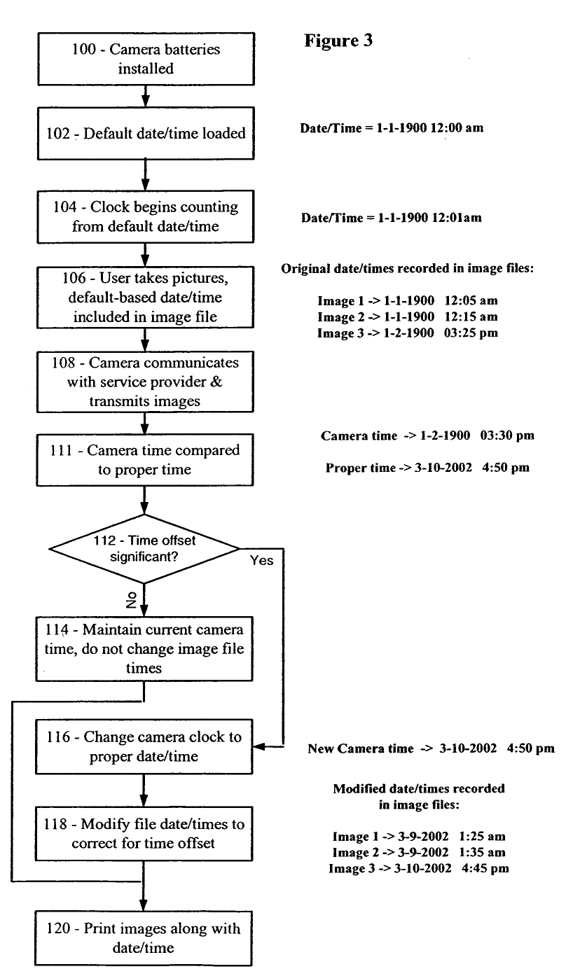

The digital photography system of FIG. 1 also includes a cellular network 400, which communicates with the digital camera 300A in order to transfer images from the digital camera 300A to an Imaging Services Provider 410. The cellular network 400 can include a network of cellular towers and communications equipment covering a region, such as the well-known cellular networks provided in the United States by Verizon and T-Mobile. The Imaging Services Provider 410 includes a network server 412, which communicates with the digital camera 300A via the cellular network 400 in order to transfer the images and store the images on an image storage system 414. As the images are transferred from the digital camera 300A to the Imaging Services Provider 410, the current date/time provided by the real-time clock in the digital camera 300A is transferred to the network server 412, which compares the camera value to the value provided by the proper date/time clock 416. If the values do not match, the network service 412 modifies the date/time metadata associated with the uploaded images, as will be described later in reference to FIG. 3.

The images transferred from the digital camera 300A to the Imaging Services Provider 410 can be printed on a printer 418 to produce hardcopy prints, which are then delivered to the user. The printer 418 can print the corrected date/time value on the back of each hardcopy print, or in a corner on the front of each hardcopy print. The Imaging Services Provider 410 can optionally store user account information concerning the type of prints, or other photo products, that each user has previously selected, as well as shipping and billing information, as described in commonly-assigned U.S. patent application Ser. No. 09/576,288 (docket 81,072), entitled “Method For Providing Customized Photo Products Over A Network” by Parulski et al., the disclosure of which is herein incorporated by reference.

The Imaging Services Provider 410 can optionally provide long-term storage of the uploaded images for each user. In this case, stored images are accessible (e.g., viewable) via the Internet by authorized users, as described, for example, in commonly-assigned U.S. Pat. No. 5,760,917 to Sheridan, the disclosure of which is herein incorporated by reference.

The digital camera 300A is shown in block diagram form in FIG. 2. Preferably, the digital camera 300A is a portable battery operated device, small enough to be easily handheld by a user when capturing and reviewing images. The digital camera 300A produces digital images that are stored on a removable memory card 330. The digital camera 300A includes a zoom lens 312 having zoom and focus motor drives 310 and an adjustable aperture and shutter (not shown). The zoom lens 312 focuses light from a scene (not shown) on an image sensor 314, for example, a single-chip color Megapixel CCD image sensor, using the well-known Bayer color filter pattern. The image sensor 314 is controlled by a timing generator 304 via CCD clock drivers 306. It should be noted that the CCD clock drivers 306 are circuits for providing high speed “clocking” control signals to the CCD image sensor 314, and are not related to the real-time clock 362.

The image sensor 314 can have, for example, 3.3 megapixels (2242×1473 pixels), of which the center 3.1 megapixels (2160×1400 pixels) are stored in the final image file after image processing. The zoom and focus motors 310, a flash 302, and the timing generator 304 are controlled by control signals supplied by a microprocessor 360. The analog output signal from the image sensor 314 is amplified and converted to digital data by an analog signal processing (ASP) and analog-to-digital (A/D) converter circuit 316. The digital data is stored in a DRAM buffer memory 318 and subsequently processed by an image processor 320 controlled by the firmware stored in firmware memory 328, which can be flash EPROM memory.

The processed digital image file is provided to a memory card interface 324, which stores the digital image file on the removable memory card 330. Removable memory cards 330 are one type of removable digital image storage medium, and are available in several different physical formats. For example, the removable memory card 330 can include memory cards adapted to the well-known PC card, Compact Flash, SmartMedia, MemoryStick, MMC or SD memory card formats. Other types of removable digital image storage media, such as magnetic hard drives, magnetic tape, or optical disks, can alternatively be used to store the still and motion digital images. Alternatively, the digital camera 300A can use internal non-volatile memory (not shown), such as internal Flash EPROM memory to store the processed digital image files. In such an embodiment, the memory card interface 324 and the removable memory card 330 are not needed.

The image processor 320 performs color interpolation followed by color and tone correction, in order to produce rendered sRGB image data. The rendered sRGB image data is then JPEG compressed and stored as a JPEG image file on the removable memory card 330. The JPEG file uses the so-called “Exif” image format defined in “Digital Still Camera Image File Format (Exif)λ version 2.1, July 1998 by the Japan Electronics Industries Development Association (JEIDA), Tokyo, Japan. This format includes an Exif application segment that stores particular image metadata, including the date/time the image was captured, as well as the lens f/number and other camera settings.

It should be noted that the image processor 320, while typically a programmable image processor, can alternatively be a hard-wired custom integrated circuit (IC) processor, a general purpose microprocessor, or a combination of hard-wired custom IC and programmable processors.

It should be further noted that instead of using the “Exif” image format, many other image formats could be used to store the processed image data and image metadata, including the date/time metadata. Examples of other formats include the well-know TIFF (Tag Image File Format), JPEG 2000, and FlashPix still image formats, and the QuickTime movie format.

The date/time value is provided by the real-time clock 362 in the microprocessor 360, which communicates with the image processor 320. Batteries 370 provide power to a power supply 372, which provides operating mode power to all of the circuits in the digital camera 300A when the digital camera 300A is turned on using an appropriate user control 303. The power supply 372 also provides standby power to the real-time clock 362 in the microprocessor 360. This enables the real-time clock 362 to continue to keep time even when the digital camera 300A is turned off.

When the batteries 370 are first inserted into the digital camera 300A, the real-time clock 362 is turned on, and is automatically initialized to an initial date/time value which provides a significantly time-shifted date, such as Jan. 1, 1900 at 12:00 am. This date is many years before any digital cameras were manufactured. The real-time clock 362 then begins to count time. The difference between the proper time at the time when the digital camera 300A begins to count, and the initial value (e.g., Jan. 1, 1900 at 12:00 am) is the time offset. The inventors of the present invention have recognized that this time offset will be the same for all captured images (unless the real-time clock 362 of the digital camera 300A is re-initialized) and can be determined long after the images have been captured, whenever the current date/time value of the digital camera 300A can be compared to a correct date/time value.

In some embodiments, when the digital camera 300A is first powered on with new batteries 370 and the real-time clock 362 is automatically initialized, a clock status storage location in a non-volatile memory (such as in firmware memory 328) is checked to see if the clock status is set to a first value (e.g., 1) and if so, it is incremented to a second value (e.g., 2). When the real-time clock 362 is then synchronized with the value in the separate device, the clock status value is set back to the first value. However, if the clock status value is set to a value other than the first value when it is checked, it is incremented to a larger value (e.g., 3). This indicates that the real-time clock 362 has been reset to the initial date/time value more than once without being synchronized, so that there are different “proper offsets” for two different groups of images. In this case, only the last group of images, captured since the last time the real-time clock 362 was reset, can be automatically set to the proper time. The others must be manually set. The clock status value can be stored as metadata with the image files, so that the groups of images having different “proper offsets” can be differentiated.

The image processor 320 also creates a low-resolution “thumbnail” size image, which can be created as described in commonly-assigned U.S. Pat. No. 5,164,831, entitled “Electronic Still Camera Providing Multi-Format Storage Of Full And Reduced Resolution Images” to Kuchta, et al., the disclosure of which is herein incorporated by reference. After images are captured, they can be quickly reviewed on a color LCD image display 332 by using the thumbnail image data. The graphical user interface displayed on the color LCD image display 332 is controlled by user controls 303.

The image processor 320 also interfaces to a cellular communications modem 350, which transmits digital images to the cellular network 400 (shown in FIG. 1) using radio frequency transmissions via an antenna 352.

FIG. 3 depicts a flow diagram showing a first embodiment of a method for correcting the date/time metadata in image files captured by the digital camera 300A in accordance with the present invention.

In block 100 of FIG. 3, the user installs the batteries 370 into the digital camera 300A. In block 102, when the user then powers on the digital camera 300A for the first time after installing the batteries 370, the real-time clock 362 is automatically initialized to the factory default time (e.g., Jan. 1, 1900, 12:00 am). In block 104, the real-time clock 362 immediately begins counting time from the default time. In other words, one minute after the digital camera 300A is powered up, the date/time will be Jan. 1, 1900, 12:01 am.

In block 106, the user captures a plurality of images, typically over an extended period of time (e.g., hours or even days). As each image is captured, the image from the image sensor 314 is processed by the image processor 320, and stored as an image file, including original date/time metadata, on the removable memory card 330. The original date/time metadata (e.g., Jan. 1, 1900, 12:05 am for the first image) is equal to the default time (e.g., Jan. 1, 1900 12:00 am) plus the time difference (e.g., 5 minutes) between the time that the real-time clock 362 was automatically initialized to the default value in block 102 and the time the image was captured in block 106.

In block 108, the digital camera 300A communicates with the Imaging Services Provider 410, in order to initiate transfer of images from the digital camera 300A to the Imaging Services Provider 410 using the cellular modem 350. The digital image files stored in block 106 are transmitted to the Imaging Services Provider 410 and stored in image storage 414 (shown in FIG. 1). The transferred image files can then be automatically deleted from the removable memory card 330.

In block 111, the current value of the real-time clock 362 in the digital camera 300A is compared to the current value of the proper date/time clock 416 (shown in FIG. 1), to determine the time offset between these two clocks. For example, the current time of the real-time clock 362 in the digital camera 300A may be Jan. 2, 1900 at 3:30 pm, while the proper time provided by proper date/time clock 416 may be Mar. 10, 2002 at 4:50 pm. In this example, the time offset is more than 100 years.

In block 112, the time difference is judged to determine if it is significant, i.e., if the time difference is greater than 24 hours. Note that smaller time differences may be the result of using a different time zone to set the real-time clock 362 of the digital camera 300A than that of the time zone of the proper date/time clock 416. The existence of a time zone difference can be determined by checking if there is an approximately integral number of hours difference between the two clocks.

If the time difference is judged to be insignificant (“No” to block 112), for example, if the time difference is only a few minutes, in block 114 the current time of the real-time clock 362 is maintained, and the original date/time metadata values of the images transmitted from the digital camera 300A are maintained.

If the time difference is judged to be significant (“Yes” to block 112), for example, if the time difference is about 100 years, then in block 116 the value of the proper date/time clock 416 is transmitted to the digital camera 300A, and the current value of the real-time clock 362 in the digital camera 300A is set to be equal to this proper date/time clock value.

In block 118, the original date/time metadata stored in the digital image files transferred to the image storage 414 are modified to correct for the time offset. This can be done, for example, by reading the date/time metadata in each of the transferred images to determine the original date/time stored when the image was captured, and adding to this original date/time value the time offset value determined in block 111, in order to “shift” the date/time value forward by the time offset. This “shifted” date/time is then checked to ensure that it is earlier in time than the current date/time provided by the proper date/time clock 416. If the “shifted” date/time is earlier in time, the original date/time metadata is replaced with the shifted date/time, in order to provide a corrected date/time value for the image. If the “shifted” date/time is later in time that the current date/time provided by the proper date/time clock 416, then the “shift” value is not applicable to that captured image, and the original date/time metadata is maintained. This may happen, for example, if the batteries 370 in the digital camera 300A were replaced some time after this particular image was taken, so that the real-time clock 362 was set properly for this image, but was later initialized to the default value when the battery power was restored.

In an alternative embodiment, the images can be maintained on the removable memory card 330 (instead of being automatically deleted), and the date/time metadata of these images is also corrected. In another alternative embodiment, the date/time metadata is corrected in the digital camera 300A before the images are transmitted to the Imaging Services Provider 410.

In block 120, the digital images are printed by the printer 418 (shown in FIG. 1) along with the correct date/time value. The date/time value can be printed on the back of the printer 418, or in a corner of the digital image. The prints are then delivered to the user (or a user's designee), for example, by the United States postal service.

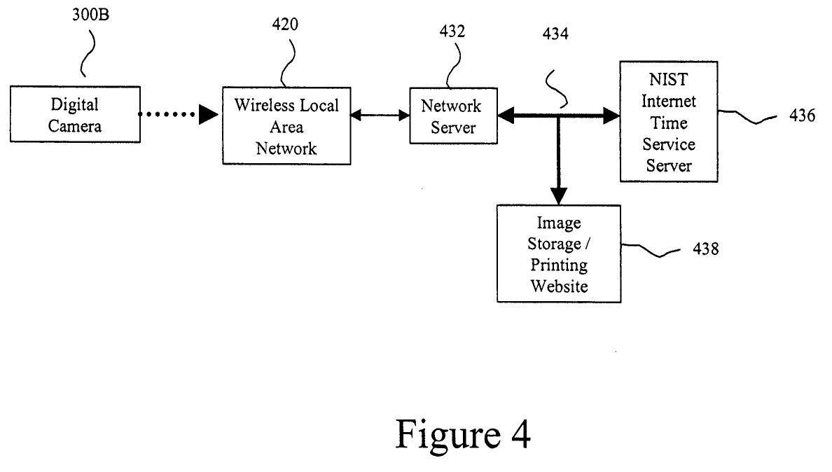

FIG. 4 depicts a block diagram of a second digital photography system. In this system, a digital camera 300B connects to a wireless local area network 420, such as an 802.11b network. The wireless local area network 420 provides a connection via a network server 432 to the Internet 434, which in turn enables the digital camera 300B to communicate with an NIST Internet Time Service server 436 and an image storage/printing website 438.

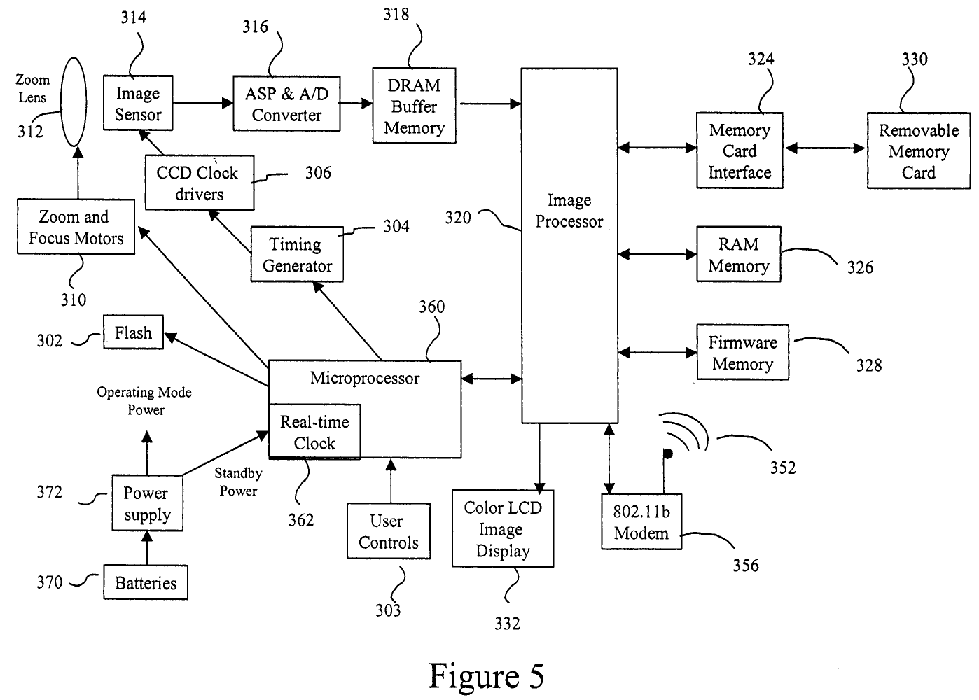

FIG. 5 depicts a block diagram of the digital camera 300B used in the digital photography system of FIG. 4. The digital camera 300B is identical to the digital camera 300A described with reference to FIG. 2, except that an 802.11b modem 356 is used in place of the cellular modem 350.

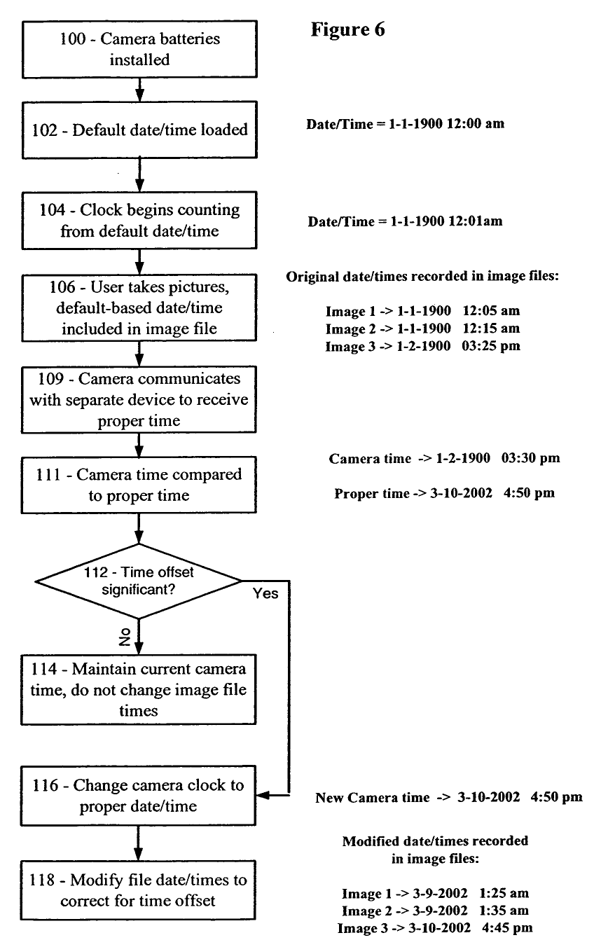

FIG. 6 depicts a flow diagram showing a second embodiment of a method for correcting the date/time metadata in image files captured by the digital camera 300B in accordance with the present invention. Blocks 100-106 of FIG. 6 are the same as blocks 100-106 in FIG. 3. In block 109 of FIG. 6, the digital camera 300B communicates with the NIST Internet Time Service server 436, via the wireless local area network 420 and the network server 432, in order to obtain the proper date/time.

The NIST Internet Time Service (ITS) server 436 allows users to synchronize computer clocks via the Internet. The service responds to time requests from any Internet client, including the digital camera 300B. The time request can use one of several formats, including the Time Protocol specified in RFC-868, the Network Time Protocol specified in RFC-1305, or the Daytime Protocol specified in RFC-867.

The time request is sent from the digital camera 300B to the IP address of the Internet Time Service serve 436r, such as one of the following

| | | |
|---|---|---|
| time-a.nist.gov | 129.6.15.28 | NIST, Gaithersburg, Maryland |
| time-b.nist.gov | 129.6.15.29 | NIST, Gaithersburg, Maryland |
| time- | 132.163.4.101 | NIST, Boulder, Colorado |
| a.timefreq.bldrdoc.gov | | |
| time- | 132.163.4.102 | NIST, Boulder, Colorado |
| b.timefreq.bldrdoc.gov | | |
| time- | 132.163.4.103 | NIST, Boulder, Colorado |
| c.timefreq.bldrdoc.gov | | |
| utcnist.colorado.edu | 128.138.140.44 | University of Colorado, Boulder |
| time.nist.gov | 192.43.244.18 | NCAR, Boulder, Colorado |
| nist1.datum.com | 66.243.43.21 | Datum, San Jose, California |
| nist1-dc.glassey.com | 216.200.93.8 | Abovenet, Virginia |

After connecting to the Internet Time Service server 436 on a particular TCP/IP port (e.g., port 13), the digital camera 300B listens for a time response in the appropriate protocol (e.g., the Time Protocol). The time returned from the Internet Time Service server 436 is UTC time (Greenwich time), and has to be corrected for the actual time zone. This can be done, for example, by determining the geographic location of the digital camera 300B from the geographical location of the specific node of the wireless local area network 420 which is currently communicating with the digital camera 300B.

In block 111 of FIG. 6, the digital camera 300B compares the proper date/time from the NIST Internet Time Service server 436 with the current date/time provided by the real-time clock 362 in the digital camera 300B. Blocks 111 through 118 are identical to the corresponding blocks in FIG. 3, except that all of the steps are performed by the image processor 320 in the digital camera 300B, which corrects the date/time metadata of the images stored on the removable memory card 330. The image files can then be transferred from the digital camera 300B to the image storage/printing website 438 (shown in FIG. 4). The website 438 can print the images along with the corrected date/time.

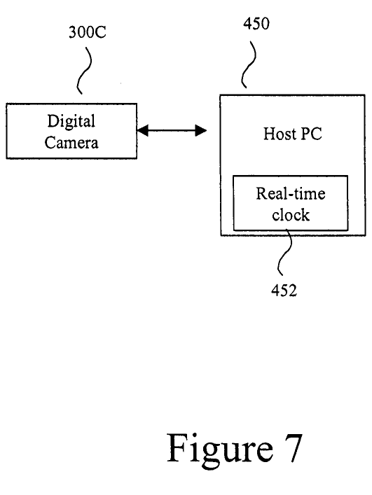

FIG. 7 depicts a block diagram of a third digital photography system. In this system, a digital camera 300C connects to a host PC 450 having a real-time clock 452, such as a personal computer using a Pentium IV processor running the Windows XP operating system. When the host PC 450 is first installed, the real-time clock 452 is normally set to the proper time by the user.

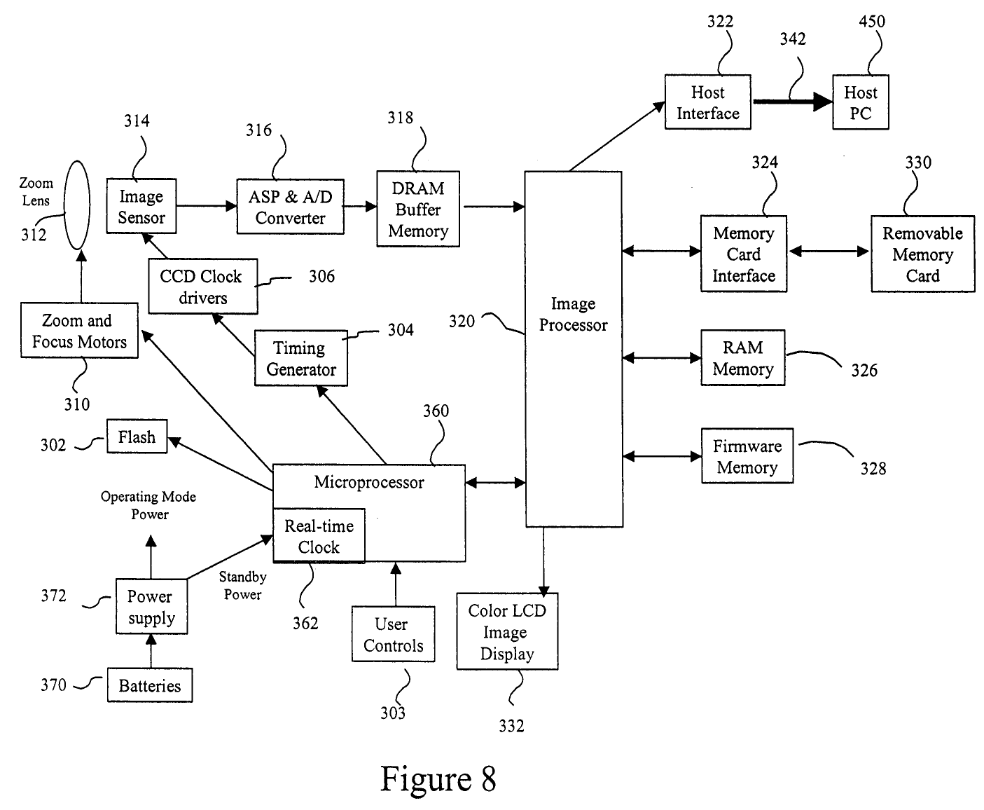

FIG. 8 depicts a block diagram of the digital camera 300C used in the digital photography system of FIG. 7. The digital camera 300C is identical to the digital camera 300A described with reference to FIG. 2, except that instead of using the cellular modem 350, the images are transferred to the host PC 450 using a host interface 322 and cable 342, which can use, for example, the well-known USB interface.

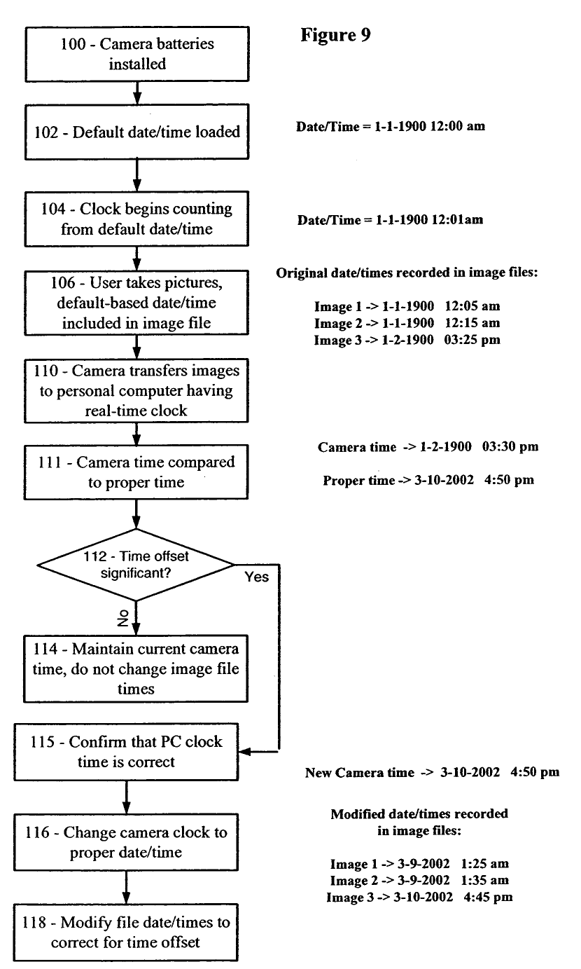

FIG. 9 depicts a flow diagram showing a third embodiment of a method for correcting the date/time metadata in image files captured by the digital camera 300C in accordance with the present invention. Blocks 100-106 of FIG. 6 are the same as blocks 100-106 in FIG. 3. In block 110 of FIG. 9, the digital camera 300C transfers the digital image files stored on the removable memory card 330 to the host PC 450, where the images are stored using a non-volatile memory (not shown) such as a hard drive. The images can then be automatically deleted from the removable memory card 330.

In block 111, the current time of the real-time clock 362 in the digital camera 300C is compared to the proper time provided by the real-time clock 452 (shown in FIG. 7) in the Host PC 450. In block 112, the time difference between the two real-time clocks is judged to determine if it is significant. If it is not significant (“No” to block 112), in block 114 the current time of the real-time clock 362 is maintained, and the original date/time metadata values of the images transferred from the digital camera 300C to the Host PC 450 are maintained.

If the time difference is significant (“Yes” to block 112 ), then in block 115 the user is asked to confirm that the real-time clock 452 in the Host PC 450 is set to the correct time. In block 116, the value of the real-time clock 452 is transferred to the digital camera 300C, and the current value of the real-time clock 362 in the digital camera 300C is set to be equal to this proper date/time clock value. In an alternative embodiment, the date/time of the host PC 450 can be automatically set using the NIST Internet Time Service server 436.

In block 118, the original date/time metadata stored in the digital image files transferred to the Host PC 450 are modified to correct for the time offset, as was described earlier in relation to block 118 of FIG. 3. In an alternative embodiment, the date/time metadata is corrected in the digital camera 300C before the images are transferred to the Host PC 450.

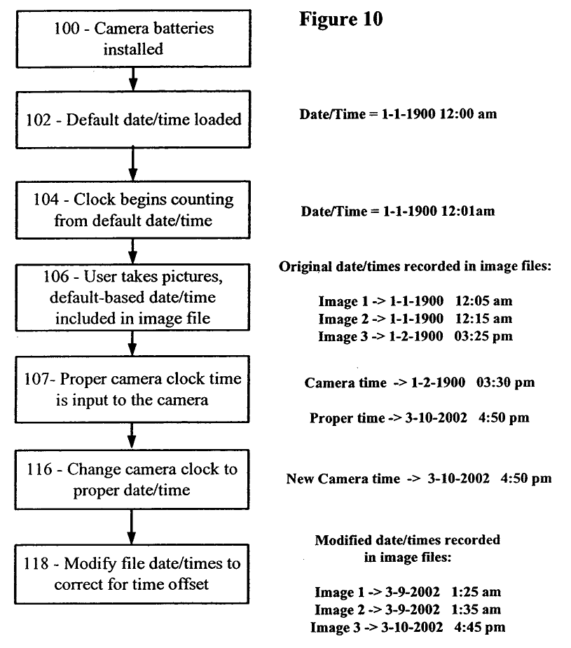

FIG. 10 depicts a flow diagram showing a fourth embodiment of a method for correcting the date/time metadata in image files captured by the digital camera 300C in accordance with the present invention. Blocks 100-106 of FIG. 6 are the same as blocks 100-106 in FIG. 3. In block 107 of FIG. 10, the proper camera clock time is input to the digital camera 300C. For example, a user of the digital camera 300C can enter the proper camera clock time using the user controls 303 in FIG. 2. This is done after the user has taken pictures in block 106, and after the captured images have been stored along with the original date/time metadata. In block 116, the real-time clock 362 in the digital camera 300C is set to the value input in block 107. In block 118, the original date/time metadata stored in the digital image files in block 106 are modified to correct for the time offset, as was described earlier in relation to block 118 of FIG. 3. The time offset is the difference between the real-time clock 362 of the digital camera 300C just before the user set the time, and the time set by the user in block 107.

A computer program product in accordance with the present invention can include one or more storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for practicing a method according to the present invention.

The invention has been described in detail with particular reference to certain preferred embodiments thereof, but it will be understood that variations and modifications can be effected within the spirit and scope of the invention.

### PARTS LIST

300A digital camera
300B digital camera
300C digital camera
302 flash
303 user controls
304 timing generator
306 CCD clock drivers
310 zoom and focus motors
312 zoom lens
314 image sensor
316 ASP & A/D converter circuit
318 DRAM buffer memory
320 image processor
322 host interface
324 memory card interface
326 RAM memory
328 firmware memory
330 removable memory card
332 color LCD image display
342 interface cable
350 cellular modem
352 antenna
356 802.11b modem
360 microprocessor
362 real-time clock
370 batteries
372 power supply
400 cellular network
410 imaging services provider
412 network server
414 image storage
416 proper date/time clock
418 printer
420 wireless local area network
432 network server
434 Internet
436 NIST Internet Time Service server
438 image storage/printing website
450 host PC
452 real-time clock

1. A method for correcting the date/time values associated with digital images captured by a digital camera, comprising:
d) using a digital camera to capture and store a plurality of digital images and to store an associated initial date/time value for each of the plurality of digital images provided by a real-time clock in the digital camera;
e) establishing communications between the digital camera and a separate device providing a current date/time value;
f) determining a current date/time value in the digital camera, and a difference between the current date/time value in the digital camera and the current date/time value in the separate device; and
d) modifying the initial date/time values associated with each of the plurality of digital images to compensate for the difference between the current date/time value in the digital camera and the current date/time value in the separate device in order to correct the date/time values associated with each of the plurality of digital images.

2. The method of claim 1 wherein each of the plurality of digital images and the initial date/time value are stored together in a digital image file.

3. The method of claim 2 wherein the digital image file is a JPEG image file.

4. The method of claim 1 wherein the plurality of digital images and the initial date/time values are transferred from the digital camera to the separate device.

5. The method of claim 1 wherein the initial date/time values are modified by the separate device.

6. The method of claim 1 wherein communications between the digital camera and the separate device is provided using a wireless communications network.

7. The method of claim 6 wherein the wireless communications network is a cellular network.

8. The method of claim 6 wherein the wireless communications network communicates with an Imaging Services Provider.

9. The method of claim 8 further including transferring the plurality of digital images to a remote storage device controlled by the Imaging Services Provider.

10. The method of claim 9 wherein the plurality of digital images are deleted from the digital camera after the plurality of digital images are transferred to the remote storage device.

11. The method of claim 9 wherein the initial date/time values associated with each of the plurality of digital images are modified before transferring the plurality of digital images to the remote storage device.

12. The method of claim 9 wherein the initial date/time values associated with each of the plurality of digital images are modified by the Imaging Services Provider after the plurality of digital images are transferred from the digital camera.

13. The method of claim 9 further including printing one of the plurality of transferred digital images with the corrected date/time.

14. The method of claim 1 wherein the separate device is a personal computer.

15. The method of claim 14 wherein communications between the digital camera and the separate device is provided using a cable interface.

16. The method of claim 15 wherein the cable interface is a USB interface.

17. The method of claim 14 the personal computer includes a real-time clock, and a user is instructed to confirm the accuracy of the real-time clock of the personal computer prior to modifying the initial date/time values associated with each of the plurality of digital images.

18. The method of claim 1 further including storing each of the plurality of digital images in a corresponding plurality of digital image files, storing the initial date/time value as date/time metadata in each of the digital image files, and modifying the date/time metadata in each of the digital files to be the corrected data/time metadata.

19. The method of claim 18 wherein each of the plurality of digital image files uses the Exif image format.

20. A method for correcting the date/time values associated with digital images captured by a digital camera, comprising:
a) initializing a real-time clock in a digital camera to a default date/time value when power is initially applied to the real-time clock;
b) using the digital camera to capture and store a plurality of digital images and associated original date/time values provided by the real-time clock;
c) receiving a date/time value;
d) determining a current date/time value of the real-time clock in the digital camera, and a difference between the received date/time value and the current date/time value in the digital camera; and
e) modifying the original date/time values associated with each of the plurality of digital images to compensate for the difference between the current date/time value in the digital camera and the received date/time value.

21. The method of claim 20 wherein the received date/time value is entered by user controls on the digital camera.

22. The method of claim 20 wherein the received date/time value is provided by a separate device.

23. The method of claim 22 wherein the separate device is a personal computer.

24. The method of claim 20 wherein the received date/time value is provided by a network server in communication with the digital camera.

25. The method of claim 24 wherein the network server is an Internet Time Service server.

26. The method of claim 25 wherein the digital camera communicates with the network server via a wireless network.

27. The method of claim 26 wherein the wireless network is an 802.11 wireless network.

28. A method for correcting the date/time values associated with digital images captured by a digital camera, comprising:
a) providing power to a real-time clock of the digital camera;
b) setting an initial date/time value for the real-time clock;
c) storing, in a non-volatile memory of the digital camera, a first clock status value indicating that the real-time clock has been set to the initial date/time value;
d) enabling the real-time clock to count time from the initial date/time value;
e) receiving a date/time value;
f) synchronizing a current date/time value of the real-time clock with the received date/time value; and
g) storing, in the non-volatile memory of the digital camera, a second clock status value indicating that the real-time clock has been synchronized with the received date/time value.

29. The method of claim 28 further including using the digital camera to capture and store a plurality of digital images and associated date/time values provided by using the real-time clock prior to synchronizing the real-time clock with the received date/time value.

30. The method of claim 29 further including modifying the date/time values associated with each of the plurality of digital images after synchronizing the real-time clock with the received date/time value.

31. The method of claim 30 wherein the plurality of digital images are stored in a corresponding plurality of digital image files, and each digital image file includes metadata indicating the clock status value.
